(19) United States
(12) Patent Application Publication
(10) Pub. No.: US 2019/0332367 A1
(43) Pub. Date: Oct. 31, 2019

(54) METHOD AND APPARATUS FOR INSTALLING APPLICATION

(71) Applicant: BOE TECHNOLOGY GROUP CO., LTD., BEIJING (CN)

(72) Inventors: Pablo NAVARRETE MICHELINI, Beijing (CN); Hanwen LIU, Beijing (CN)

(21) Appl. No.: 16/201,143

(22) Filed: Nov. 27, 2018

(30) Foreign Application Priority Data
Apr. 27, 2018 (CN) 201810393640.1

(51) Int. Cl. G06F 8/61; H04L 29/06

(52) U.S. Cl. CPC G06F 8/61; H04L 65/4023

(57) ABSTRACT

A method and an apparatus for installing an application are disclosed. The method comprises: receiving a request to install the application; triggering running of a script to obtain installation information of the selected application and a target virtual environment corresponding to the selected application; processing the installation information of the selected application according to compiling rules and installing rules corresponding to the installation information and the target virtual environment to cause the selected application to be installed into the target virtual environment.

### CROSS-REFERENCE TO RELATED APPLICATIONS

This application claims priority to Chinese Patent Application No. 201810393640.1, filed on Apr. 27, 2018, the entire disclosure of which is incorporated herein by reference.

### TECHNICAL FIELD

The present application relates to a method and an apparatus for installing an application.

### BACKGROUND

With continuous development of the computer technology, a number of pieces of application software are developed and used, such that terminal functions are greatly enriched. There is a problem of compatibility among different applications. After a downloaded application is added to a system application library defaulted by the operating system, if the newly added application is not compatible with other applications in the system application library, the newly added application cannot be run, and running of the other applications will also be affected.

In order to avoid the problem of incompatibility among the applications, generally one or more virtual environments independent of one another are created locally on the terminal. Since applications installed into the virtual environments are run independently, the occurring of the problem of incompatibility among the applications will be avoided.

At present, a main technique to create the virtual environments is an Application Container Engine (Docker) technique. The Docker technique establishes a completely independent virtual environment, i.e., a Docker container, which is configured with an independent operating system, and the independent operating system is used to control downloading of an application and installation of the application into the Docker container.

The independent operating system can download installation information including source codes and installation commands of the application. There is generally a plurality of installation commands. During the process of installing the application into the Docker container by the operating system, if one of the installation commands has a problem during its execution, the operating system needs to re-execute all the installation commands of the application, which results in a long time for installing the application and a low application installing efficiency. In addition, it is very complicated to establish independent operating systems, which increases difficulty and cost in the software development.

### SUMMARY

Embodiments of the present application disclose a method for installing an application, comprising:

receiving a request to install the application;

triggering running of a script to obtain installation information of a selected application and a target virtual environment corresponding to the selected application;

and processing the installation information of the selected application according to compiling rules and installing rules corresponding to the installation information and the target virtual environment to cause the selected application to be installed into the target virtual environment.

According to some embodiments of the present application, a step of triggering running of the script to obtain the installation information of the selected application and the target virtual environment corresponding to the selected application comprises:

triggering running of the script to access and download the installation information of the selected application via a network.

According to some embodiments of the present application, a step of triggering running of the script to access and download the installation information of the selected application via the network comprises:

triggering running of the script to output a configuration interface;

receiving search information of the selected application and the target virtual environment corresponding to the selected application which are inputted by a user in the configuration interface, the search information comprising at least one of identification information and a download link; and accessing and downloading the installation information of the selected application via the network based on the search information of the selected application.

According to some embodiments of the present application, a step of triggering running of the script to access and download the installation information of the selected application via the network comprises:

determining a download link of the selected application based on a correspondence relationship between the application and the download link; and

downloading the installation information of the selected application by accessing the download link.

According to some embodiments of the present application, prior to a step of accessing and downloading the installation information of the selected application via the network, the method further comprises:

determining that the installation information of the selected application is not stored in a storage space.

According to some embodiments of the present application, a step of triggering running of the script to obtain the installation information of the selected application and the target virtual environment corresponding to the selected application comprises:

acquiring the installation information of the selected application from a storage space in response to determining that the installation information of the selected application is stored in the storage space.

According to some embodiments of the present application, after a step of processing the installation information of the selected application according to the compiling rules and the installing rules corresponding to the installation information and the target virtual environment to cause the selected application to be installed into the target virtual environment, the method further comprises:

recording a storage path of the selected application; and

transmitting the storage path to a physical machine operating system for storage therein to enable the physical machine operating system to search out the selected application based on the storage path.

The embodiments of the present application further disclose an apparatus for installing an application, comprising:
a request receiving circuit configured for receiving a request to install the application;

an information acquisition circuit configured for triggering running of a script to obtain installation information of the selected application and a target virtual environment corresponding to the selected application; and an application installation circuit configured for processing the installation information of the selected application according to compiling rules and installing rules corresponding to the installation information and the target virtual environment to cause the selected application to be installed into the target virtual environment.

According to some embodiments of the present application, the information acquisition circuit is further configured for triggering running of the script to access and download the installation information of the selected application via a network.

According to some embodiments of the present application, the information acquisition circuit comprises:

an interface output sub-circuit configured for triggering running of the script to output a configuration interface;

an information receiving sub-circuit configured for receiving search information of the selected application and the target virtual environment corresponding to the selected application which are inputted by a user in the configuration interface, the search information comprising at least one of identification information and a download link; and an information downloading sub-circuit configured for accessing and downloading the installing information of the selected application via the network based on the search information of the selected application.

According to some embodiments of the present application, the information acquisition circuit comprises:

a link determination sub-circuit configured for determining a download link of the selected application based on a correspondence relationship between the application and the download link; and an information acquisition sub-circuit configured for downloading the installation information of the selected application by accessing the download link.

According to some embodiments of the present application, the apparatus for installing the application further comprises:
an information determination circuit configured for determining, prior to accessing and downloading the installation information of the selected application via the network, that the installation information of the selected application is not stored in a storage space.

According to some embodiments of the present application, the information acquisition circuit is further configured for acquiring the installation information of the selected application from a storage space in response to determining that the installation information of the selected application is stored in the storage space.

According to some embodiments of the present application, the apparatus for installing the application further comprises:

a path recording circuit configured for recording a storage path of the selected application after processing the installation information of the selected application according to the compiling rules and the installing rules corresponding to the installation information and the target virtual environment to cause the selected application to be installed into the target virtual environment; and a path transmitting circuit configured for transmitting the storage path to a physical machine operating system for storage therein to enable the physical machine operating system to search out the selected application based on the storage path.

The embodiments of the present application further disclose a non-volatile computer-readable storage medium, instructions in the non-volatile computer-storage medium, when being executed by a processor in an electronic device, causing the electronic device to perform steps of:

receiving a request to install the application;

triggering running of a script to obtain installation information of a selected application and a target virtual environment corresponding to the selected application;

and processing the installation information of the selected application according to compiling rules and installing rules corresponding to the installation information and the target virtual environment to cause the selected application to be installed into the target virtual environment.

The embodiments of the present application further disclose an electronic device, comprising: a processor, a memory and a computer program stored on the memory and executable on the processor, the computer program, when executed by the processor, performing steps of:

receiving a request to install the application;

triggering running of a script to obtain installation information of a selected application and a target virtual environment corresponding to the selected application;

and processing the installation information of the selected application according to compiling rules and installing rules corresponding to the installation information and the target virtual environment to cause the selected application to be installed into the target virtual environment.

### DESCRIPTIONS OF DRAWINGS

FIG. 1 illustrates a flow chart showing steps of a method for installing an application provided by the embodiments of the present application.

FIG. 2 illustrates a flow chart showing steps of another method for installing an application provided by the embodiments of the present application.

FIG. 3 illustrates a structural schematic diagram of an apparatus for installing an application provided by the embodiments of the present application.

### DETAILED DESCRIPTION

In order to make the above-mentioned objectives, features and advantages of the present application clearer, the present application is further described in detail below with reference to the drawings and the embodiments.

The independent operating system can download installation information of the application, such as source codes and installation commands. There is generally a plurality of installation commands. During the process of installing the application into the Docker container by the operating system, if one of the installation commands has a problem during its execution, it is necessary for the operating system to re-execute all the installation commands of the application, which results in a long time for installing the application and a low efficiency of installing the application. In addition, it is very complicated to establish the independent operating systems, which increases difficulty and cost in the software development.

The present application provides a method and an apparatus for installing an application, so as to solve such a problem in the existing technical solution that if one of the installation commands has a problem during its execution, it is necessary for the operating system to re-execute all the installation commands of the application, which results in a long time for installing the application and a low efficiency of installing the application.

Compared with the prior art, the present application has the following advantages:

The embodiments of the present application provide a method and an apparatus for installing an application, in which a script is used to execute downloading and installation of the application, and compiling rules and installing rules may be preset in the script. When a problem occurs during the installation of the selected application, the script will solve the installation problem according to the compiling rules and the installing rules and continue to perform the remaining installation, thereby ensuring the selected application is successfully installed into the target virtual environment and the updating of the target virtual environment is completed. Since it is unnecessary to re-execute all the installation processes, the time for installing the application is greatly reduced, and the efficiency of installing the application is increased. Meanwhile, compared with the independent operating system in the background art, the script is advantageous for simple development of software, small size of codes and low cost.

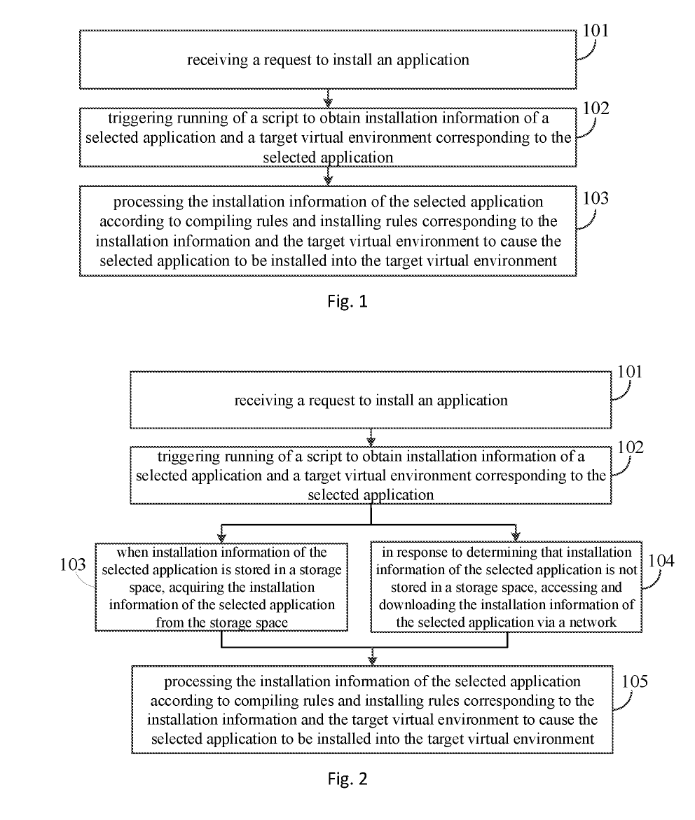

With reference to FIG. 1, a flow chart showing steps of a method for installing an application provided by the embodiments of the present application is illustrated, which may comprise, for example:

Step 101: receiving a request to install an application.

In the embodiments of the present application, at least one virtual environment is created in the terminal in advance. When two or more virtual environments are created, the two or more virtual environments are independent of one another. There are various forms in which the virtual environments are stored, including, for example, being stored in folders. Meanwhile, a script developed in advance is stored in the terminal. The script is used for downloading the application and installing the application into the virtual environment.

When a user pre-installs the application into the virtual environment, the user may send to the terminal a request to install the application. For example, the user may send to the terminal the request to install the application via a specified operation.

Step 102: triggering running of a script to obtain installation information of the selected application and a target virtual environment corresponding to the selected application.

The selected application is an application which is pre-downloaded by the user and installed to the virtual environment. The installation information of the selected application is information for installing the selected application into the virtual environment. The installation information may include information such as source codes and installation commands. The target virtual environment is a virtual environment for storing the selected application.

After the request to install the application is received, the running of a script is triggered to obtain the installation information of the selected application and the target virtual environment corresponding to the selected application via the script.

There are various ways in which the installation information and the target virtual environment is obtained via the script, including, for example, outputting a configuration interface after triggering the running of the script, receiving the target virtual environment inputted by the user in the configuration interface of the script so as to obtain the target virtual environment, and accessing and obtaining the installation information via a network and so on. The way of obtaining the installation information and the target virtual environment may be set according to practical conditions.

Step 103: processing the installation information of the selected application according to compiling rules and installing rules corresponding to the installation information and the target virtual environment to cause the selected application to be installed into the target virtual environment.

In the embodiments of the present application, the compiling rules and the installing rules of the application are prestored in the script. The compiling rules and the installing rules of the application correspond to the installation information and the target virtual environment of the application. Different target virtual environments may correspond to different installing rules. According to the present application, after obtaining the installation information of the selected application, the compiling rules and the installing rules corresponding to the installation information and the target virtual environment are determined, and then based on the determined compiling rules and the installing rules, the installation information of the selected application is processed to install the selected application into the target virtual environment.

The installation information may include various information of the application. For example, the installation information may include source codes, multiple installation commands and so on of the selected application. When the installation information includes the source codes and the multiple installation commands of the selected application, if one of the installation commands has a problem during installation of the selected application, the script suspends installation of the selected application and deals with the installation problem based on the installing rules of the selected application, and when the installation problem is solved, execution of the remaining installation is continued to ensure that the selected application is successfully installed into the target virtual environment. Since it is unnecessary to re-execute all the installation processes, the time for installing the application is greatly reduced and the efficiency of installing the application is increased.

There is a plurality of ways to implement the above functions of the script. For example, the compiling rules and the installing rules stored in the script may define an installing order of the multiple installation commands of the selected application. During the installation of the application, when one of the installation commands has a problem, the script records a position of the installation command, which has the problem, in all the installation commands, and when the problem of the installation command is solved, the script continues to execute the remaining installation commands according to the recorded position of the installation command which has the problem to complete the remaining installation process.

In practice, the compiling rules and the installing rules of different applications may be stored in the script in advance. When the script receives the installation information of the selected application, it determines the compiling rules and the installing rules corresponding to the installation information and the target virtual environment. If the corresponding compiling rules and the installing rules are not stored in the script, the script may output a prompt message to the user for viewing. At this time, the user may input the compiling rules and the installing rules corresponding to the selected application via a configuration interface outputted by the script to update the correspondence relationship between the application and rules stored in the script.

Generally, the installation information of the application relates to a plurality of factors, such as the type of the application, the version of the application and so on. The compiling rules and the installing rules relate to a plurality of factors, such as the type of the application, the version of the application, the target virtual environment and so on. It may also be understood that the compiling rules and the installing rules relate to the installation information and the target virtual environment of the application. According to the present application, a correspondence relationship among application information (e.g., an application name, an application version, the installation information of the application), the target virtual environment, the compiling rules and the installing rules may be stored in the script to facilitate searching for the desired compiling rules and the installing rules. There may also be other forms of correspondence relationships, which will not be limited here in the embodiments of the present application.

The language environment of the virtual environment may be set according to practical conditions. For example, a Python language environment is set. The Python application may be compiled in the Python language environment. The version of 2.7.6 and the version of 3.6.2 may be installed simultaneously in the Python language environment. The Python application of the desired version may be downloaded and installed according to the user's selection.

The embodiments of the present application may use the following standard development tools: Makefile file, Script (Bash or Windows Batch File) and command line downloading programs (e.g., wget, aria2 and so on). Other suitable development tools may also be used.

The script has a very small size which may reach 1 MB or below. Thus, the use of the script to download and install the application into the virtual environment will greatly reduce the amount of written codes and simplify the software development. The script provided by the embodiments of the present application may be used to download an open source application and install the open source application into the virtual environment. Thus, it is allowable to develop a public open source application, and during the development, the application may be compiled more than once as necessary. Since the plurality of virtual environments created in the terminal are independent of one another, when a new virtual environment is installed and tested, no influence would be imposed on the other virtual environments in use. The application may be installed into the new virtual environment by the configuration.

The embodiments of the present application provide a method and an apparatus for installing an application, in which a script is used to execute downloading and installation of the application, and compiling rules and installing rules may be preset in the script. When a problem occurs during the installation of the selected application, the script will solve the installation problem according to the compiling rules and the installing rules and continue to perform the remaining installation, thereby ensuring the selected application is successfully installed into the target virtual environment and the updating of the target virtual environment is completed. Since it is unnecessary to re-execute all the installation processes, the time for installing the application is greatly reduced, and the efficiency of installing the application is increased. Meanwhile, compared with the independent operating system in the background art, the script is advantageous for simple development of software, small size of codes and low cost.

With reference to FIG. 2, a flow chart showing steps of another method for installing an application provided by the embodiments of the present application is illustrated, which comprises:

Step 201: receiving a request to install an application.

Step 202: triggering running of a script to obtain installation information of the selected application and a target virtual environment corresponding to the selected application.

In the embodiments of the present application, the installation information of the selected application may be downloaded in advance to a specified storage space. There may be a plurality of kinds of storage spaces, such as buffer and so on. The capacity of the storage space may be set according to practical conditions. For example, the storage space may be a buffer having a size greater than 5 GB.

The method for installing the application according to the embodiments of the present application may be applied to a terminal within which a physical machine operating system is provided. The physical machine operating system is an OS (Operating System) as generally called, which is a computer program for managing and controlling computer hardware and software resources. The physical machine operating system corresponds to a physical environment. Moreover, within the terminal provided by the present application, a virtual machine operating system is further provided. The virtual machine operating system corresponds to a virtual environment. A position of said storage space may be set according to practical conditions. For example, the storage space may be set within the physical environment to facilitate searching thereof.

Step 203: when the installation information of the selected application is stored in the storage space, obtaining the installation information of the selected application from the storage space.

After the script is run, the script may firstly perform a step of determining whether the installation information of the selected application is stored in the storage space. When it is determined that the installation information of the selected application is stored in the storage space, the installation information of the selected application is directly extracted from the storage space.

If the installation information is not stored in the storage space, the installation information which is not stored may be downloaded into the storage space in a manner of a network downloading to update the information content in the storage space to facilitate succeeding use.

Since it is unnecessary to download the installation information via the network, the process of obtaining the installation information is simplified, thereby reducing the time for downloading the installation information and the time for installing the application, and thus further improving the efficiency of installing the application. When the terminal is not connected to the network, the method may implement the obtaining of the installation information of the selected application, and thus implement the installing of the selected application. Hence, the solution is adaptable to a scenario in which the terminal is not connected to the network.

Step 204: in response to determining that the installation information of the selected application is not stored in the storage space, accessing and downloading the installation information of the selected application via network.

When it is determined that the installation information of the selected application is not stored in the storage space, the installation information of the selected application is accessed and downloaded via the network. It is necessary to perform this operation in a scenario in which the terminal is connected to the network.

There are a plurality of ways to access and download the installation information of the selected application via the network, including, for example, a first way comprising triggering running of a script to output a configuration interface, receiving search information of the selected application and a target virtual environment corresponding to the selected application which are inputted by a user in the configuration interface, the search information at least including at least one of identification information and a download link, and downloading the installation information of the selected application via the network according to the search information of the selected application; and a second way comprising determining a download link of the selected application according to a correspondence relationship between the prestored application and the download links, and downloading the installation information of the selected application by accessing the download link.

In said first way, after the configuration interface is outputted, when the script receives the download link of the selected application inputted by the user in the configuration interface, the script may download the installation information by directly accessing the download link. There are a plurality of ways to input the download link, including, for example, selecting from a plurality of download links displayed on the configuration interface, or being written directly by the user; when the script receives the identification information of the selected application inputted by the user in the configuration interface, the script may access the network to search for a download link corresponding to the identification information and download the installation information of the selected application by accessing the download link via the network. Download links of different applications may be recorded in the script, and the plurality of download links may be stored in the form of a list or in other forms. The user may update the download link recorded in the script as necessary to satisfy the user's demand and facilitate downloading of the application.

In said second way, the script may pre-store a correspondence relationship between the application and the download link. For example, the correspondence relationship between the identification information of the application and the download link may be stored. After the application inputted by the user in the configuration interface is received, a download link corresponding to the application is searched, and the installation information of the selected application is downloaded by accessing the download link.

The information content of the identification information of the application may include multiple kinds, including, for example, one or more of application names, application versions and application icons, which may be set according to practical conditions.

Step 205: processing the installation information of the selected application according to compiling rules and installing rules corresponding to the installation information and the target virtual environment to cause the selected application to be installed into the target virtual environment.

In the embodiments of the present application, the compiling rules and the installing rules are preset in the script. When the selected application is installed according to the preset compiling rules and the installing rules, a protocol permission interface of the application will not be popped out, but instead, the protocol of the application will be permitted in default so as to ensure the user is authorized to download and install the application without an operation of re-granting the protocol, thereby improving the user experience.

In the embodiments of the present application, after the installation information of the selected application is processed according to the preset compiling rules and the installing rules to cause the selected application to be installed into the target virtual environment, the method may further comprises: recording a storage path of the selected application, and then transmitting the storage path to a physical machine operating system for storage therein to enable the physical machine operating system to rapidly search out the selected application according to the storage path. A storage position of the storage path in the physical machine operating system may be set according to practical conditions. For example, the storage path may be stored in an environmental variable of the physical machine operating system. The recording of the storage path of the selected application and the storing of it in the physical machine operating system reduces the time to search for the selected application by the physical machine operating system and improves the efficiency of searching for the selected application. In practice, the storage path of the selected application may be transmitted to a virtual machine operating system for storage therein as necessary.

When the physical machine operating system searches for the selected application, firstly it may be determined whether the storage path of the selected application is stored. If the specified path is stored, the selected application may be rapidly searched out according to the storage path. If the storage path is not stored, the virtual environment is preferentially searched. When there is a plurality of virtual environments, the physical machine operating system may search the plurality of virtual environments in sequence. When all the virtual environments are searched without searching out the selected application, the selected application is searched in a system application library of the physical machine operating system.

The embodiments of the present application provide a method and an apparatus for installing an application, in which a script is used to execute downloading and installation of the application, and compiling rules and installing rules may be preset in the script. When a problem occurs during the installation of the selected application, the script will solve the installation problem according to the compiling rules and the installing rules and continue to perform the remaining installation, thereby ensuring the selected application is successfully installed into the target virtual environment and the updating of the target virtual environment is completed. Since it is unnecessary to re-execute all the installation processes, the time for installing the application is greatly reduced, and the efficiency of installing the application is increased. Meanwhile, compared with the independent operating system in the background art, the script is advantageous for simple development of software, small size of codes and low cost.

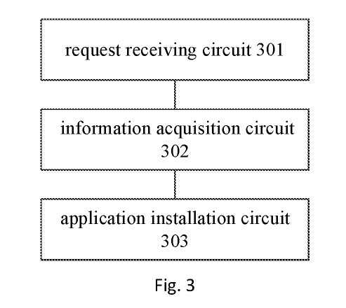

Referring to FIG. 3, a structural schematic diagram of an apparatus for installing an application provided by the embodiment of the present application is illustrated, which may comprise, for example:

a request receiving circuit 301 configured for receiving a request to install an application;

an information acquisition circuit 302 configured for triggering running of a script to obtain installation information of the selected application and a target virtual environment corresponding to the selected application; and

an application installation circuit 303 configured for processing the installation information of the selected application according to compiling rules and installing rules corresponding to the installation information and the target virtual environment to cause the selected application to be installed into the target virtual environment.

According to some embodiments of the present application, the information acquisition circuit 302 is further configured for triggering running of the script to access and download the installation information of the selected application via a network.

According to some embodiments of the present application, the information acquisition circuit 302 comprises:

an interface output sub-circuit configured for triggering running of the script to output a configuration interface;

an information receiving sub-circuit configured for receiving search information of the selected application and the target virtual environment corresponding to the selected application which are inputted by a user in the configuration interface, the search information comprising at least one of identification information and a download link; and

an information downloading sub-circuit configured for accessing and downloading the installing information of the selected application via the network based on the search information of the selected application.

According to some embodiments of the present application, the information acquisition circuit 302 comprises:

a link determination sub-circuit configured for determining a download link of the selected application based on a correspondence relationship between the application and the download link; and

an information acquisition sub-circuit configured for downloading the installation information of the selected application by accessing the download link.

According to some embodiments of the present application, the apparatus for installing the application further comprises:

an information determination circuit configured for determining, prior to accessing and downloading the installation information of the selected application via the network, that the installation information of the selected application is not stored in a storage space.

According to some embodiments of the present application, the information acquisition circuit is further configured for acquiring the installation information of the selected application from a storage space in response to determining that the installation information of the selected application is stored in the storage space.

According to some embodiments of the present application, the apparatus for installing the application further comprises:

a path recording circuit configured for recording a storage path of the selected application after processing the installation information of the selected application according to the compiling rules and the installing rules corresponding to the installation information and the target virtual environment to cause the selected application to be installed into the target virtual environment; and

a path transmitting circuit configured for transmitting the storage path to a physical machine operating system for storage therein to enable the physical machine operating system to search out the selected application based on the storage path.

The embodiments of the present application provide a method and an apparatus for installing an application, in which a script is used to execute downloading and installation of the application, and compiling rules and installing rules may be preset in the script. When a problem occurs during the installation of the selected application, the script will solve the installation problem according to the compiling rules and the installing rules and continue to perform the remaining installation, thereby ensuring the selected application is successfully installed into the target virtual environment and the updating of the target virtual environment is completed. Since it is unnecessary to re-execute all the installation processes, the time for installing the application is greatly reduced, and the efficiency of installing the application is increased. Meanwhile, compared with the independent operating system in the background art, the script is advantageous for simple development of software, small size of codes and low cost.

The embodiments of the present application further disclose an electronic device, comprising: a processor, a memory and a computer program stored on the memory and executable on the processor, the computer program, when executed by the processor, performing the method for installing the application as described in the above embodiments, and the same technical effect can be achieved. In order to avoid repetition, the detailed description thereof is omitted here.

The embodiments of the present application further disclose a non-volatile computer-readable storage medium storing a computer program thereon, which, when executed by a processor, performs the method for installing the application according to the above embodiment, and the same technical effect can be achieved. In order to avoid repetition, the detailed description is omitted here. The non-volatile computer-readable storage medium is, for example, a Read-Only Memory (ROM), a Random-Access Memory (RAN), a disk or an optical disk.

In order to describe the embodiments of the various methods in a simple way, they are described as a combination of a series of actions, but it shall be known to those skilled in the art that the present application is not limited by the sequence of the actions as described, since according to the present application, certain steps may be performed in other sequences or concurrently. Secondly, it shall also be known to those skilled in the art that the embodiments described in the description are preferred embodiments, and the actions and circuits involved therein may not be essential to the present application.

The respective embodiments in the present description are described in a progressive manner, the specification of each of the embodiments is focused on its difference with respect to the other embodiments, and the identical or similar parts of the respective embodiments can be known with reference to one another.

Finally, it is to be noted that terms used herein to describe relationships such as a first and a second are only used to distinguish one entity or operation from another, but shall not require or suggest that these entities or operations have such an actual relationship or sequence. Furthermore, the term “comprising”, “including” or any other variations intends to cover other nonexclusive containing relationships to ensure that a process, a method, a product or an apparatus comprising a series of factors comprises not only those factors, but also other factors not explicitly listed, or further comprises factors inherent to the process, the method, the product or the apparatus. Without more limitations, a factor defined with the sentence “comprising one . . . .” does not exclude the case that the process, the method, the product or the apparatus comprising said factor still comprises other identical factors.

A method and an apparatus for installing an application provided by the present application are described in detail above. Herein, specific examples are used to demonstrate the principles and the embodiments of the present application. Said examples are used only to help understanding the method and the core concept of the present application. Moreover, those skilled in the art, based on the concept of the present application, may modify the embodiment and the application range. In summary, the contents of the description shall not be understood as limitations to the present application.

What is claimed is:

1. A method for installing an application, comprising:
receiving a request to install the application;
triggering running of a script to obtain installation information of a selected application and a target virtual environment corresponding to the selected application; and
processing the installation information of the selected application according to compiling rules and installing rules corresponding to the installation information and the target virtual environment to cause the selected application to be installed into the target virtual environment.

2. The method for installing the application according to claim 1, wherein a step of triggering running of the script to obtain the installation information of the selected application and the target virtual environment corresponding to the selected application comprises:
triggering running of the script to access and download the installation information of the selected application via a network.

3. The method for installing the application according to claim 2, wherein a step of triggering running of the script to access and download the installation information of the selected application via the network comprises:
triggering running of the script to output a configuration interface;
receiving search information of the selected application and the target virtual environment corresponding to the selected application which are inputted by a user in the configuration interface, the search information comprising at least one of identification information and a download link; and
accessing and downloading the installation information of the selected application via the network based on the search information of the selected application.

4. The method for installing the application according to claim 2, wherein a step of triggering running of the script to access and download the installation information of the selected application via the network comprises:
determining a download link of the selected application based on a correspondence relationship between the application and the download link; and
downloading the installation information of the selected application by accessing the download link.

5. The method for installing the application according to claim 2, wherein prior to a step of accessing and downloading the installation information of the selected application via the network, the method further comprises:
determining that the installation information of the selected application is not stored in a storage space.

6. The method for installing the application according to claim 1, wherein a step of triggering running of the script to obtain the installation information of the selected application and the target virtual environment corresponding to the selected application comprises:
acquiring the installation information of the selected application from a storage space in response to determining that the installation information of the selected application is stored in the storage space.

7. The method for installing the application according to claim 1, wherein after a step of processing the installation information of the selected application according to the compiling rules and the installing rules corresponding to the installation information and the target virtual environment to cause the selected application to be installed into the target virtual environment, the method further comprises:
recording a storage path of the selected application; and
transmitting the storage path to a physical machine operating system for storage therein to enable the physical machine operating system to search out the selected application based on the storage path.

8. An apparatus for installing an application, comprising:
a request receiving circuit configured for receiving a request to install the application;
an information acquisition circuit configured for triggering running of a script to obtain installation information of the selected application and a target virtual environment corresponding to the selected application; and
an application installation circuit configured for processing the installation information of the selected application according to compiling rules and installing rules corresponding to the installation information and the target virtual environment to cause the selected application to be installed into the target virtual environment.

9. The apparatus for installing the application according to claim 8, wherein:
the information acquisition circuit is further configured for triggering running of the script to access and download the installation information of the selected application via a network.

10. The apparatus for installing the application according to claim 8, wherein the information acquisition circuit comprises:
an interface output sub-circuit configured for triggering running of the script to output a configuration interface;
an information receiving sub-circuit configured for receiving search information of the selected application and the target virtual environment corresponding to the selected application which are inputted by a user in the configuration interface, the search information comprising at least one of identification information and a download link; and
an information downloading sub-circuit configured for accessing and downloading the installing information of the selected application via the network based on the search information of the selected application.

11. The apparatus for installing the application according to claim 9, wherein the information acquisition circuit comprises:
a link determination sub-circuit configured for determining a download link of the selected application based on a correspondence relationship between the application and the download link; and
an information acquisition sub-circuit configured for downloading the installation information of the selected application by accessing the download link.

12. The apparatus for installing the application according to claim 9, wherein the apparatus for installing the application further comprises:
an information determination circuit configured for determining, prior to accessing and downloading the installation information of the selected application via the network, that the installation information of the selected application is not stored in a storage space.

13. The apparatus for installing the application according to claim 8, wherein the information acquisition circuit is further configured for acquiring the installation information of the selected application from a storage space in response to determining that the installation information of the selected application is stored in the storage space.

14. The apparatus for installing the application according to claim 8, wherein the apparatus for installing the application further comprises:
a path recording circuit configured for recording a storage path of the selected application after processing the installation information of the selected application according to the compiling rules and the installing rules corresponding to the installation information and the target virtual environment to cause the selected application to be installed into the target virtual environment; and
a path transmitting circuit configured for transmitting the storage path to a physical machine operating system for storage therein to enable the physical machine operating system to search out the selected application based on the storage path.

15. An electronic device, comprising: a processor, a memory and a computer program stored on the memory and executable on the processor, the computer program, when executed by the processor, performing steps of:
receiving a request to install the application;
triggering running of a script to obtain installation information of a selected application and a target virtual environment corresponding to the selected application; and
processing the installation information of the selected application according to compiling rules and installing rules corresponding to the installation information and the target virtual environment to cause the selected application to be installed into the target virtual environment.

16. A non-volatile computer-readable storage medium, instructions in the non-volatile computer-storage medium, when being executed by a processor in an electronic device, causing the electronic device to perform steps of:
receiving a request to install the application;
triggering running of a script to obtain installation information of a selected application and a target virtual environment corresponding to the selected application; and
processing the installation information of the selected application according to compiling rules and installing rules corresponding to the installation information and the target virtual environment to cause the selected application to be installed into the target virtual environment.
